(19) United States
(12) Patent Application Publication
(10) Pub. No.: US 2006/0081012 A1
(43) Pub. Date: Apr. 20, 2006

(54) Sol-Gel method and method for manufacturing optical crystal fiber using the same

(75) Inventors: Keun-Deok Park, Busan (KR); Soon-Jae Kim, Gumi-si (KR); Jin-Han Kim, Gumi-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/216,310

(22) Filed: Aug. 31, 2005

(30) Foreign Application Priority Data
Oct. 18, 2004 (KR) 2004-83003

(51) Int. Cl. C03B 37/016

(52) U.S. Cl. 65/395; 65/440

(57) ABSTRACT

A sol-gel process is disclosed. The process includes the steps of creating a sol by dispersing an organic binder having Si—O backbone structure into de-ionized water together with fumed silica, injecting the dispersed sol into a mold to form a gel, drying the gel, removing organic substances remaining in the gel, removing impurities remaining in the gel and OH radicals, and heating the gel at a temperature to improve the consolidation of the gel.

### CLAIM OF PRIORITY

This application claims priority to an application entitled “Sol-Gel Method and Method for Manufacturing Optical Crystal Fiber Using the Same,” filed with the Korean Intellectual Property Office on Oct. 18, 2004 and assigned Serial No. 2004-83003, the contents of which are hereby incorporated by reference.

### BACKGROUND OF THE INVENTION

1. Field of the Invention

The present invention relates to a method for manufacturing optical fiber preforms and optical crystal fibers, and more particularly to a method for manufacturing optical fiber preforms and optical crystal fibers using a sol-gel process.

2. Description of the Related Art

In general, silica glass is transparent and chemically inactive. It has excellent physical or chemical characteristics such as thermal stability and strength. In addition, the silica glass has low thermal expansion coefficient and is widely used to manufacture optical devices such as optical fibers and lenses.

Methods for manufacturing the silica glass include a vapor axial deposition method and a sol-gel method. The sol-gel method is conducted in a liquid state. and the sol-gel method can adjust the product composition as desired. The sol-gel method is also performed at a lower temperature than the vapor axial deposition method. In addition, the sol-gel method is more economically advantageous and can create compositions of complex components.

Conventional sol-gel manufacturing methods include a dispersion step, a formation step, a drying step, a heat treatment step, a chlorine treatment step, and a high-temperature heat treatment step.

In the dispersion step, fumed silica such as alkoxysilane, a dispersion agent, a plasticizer, and an organic binder are mixed with one another in a solution such as alcohol or de-ionized water to form a sol. The formed sol is conditioned for a period of time.

The mixed sol is subjected to a very large stress during gelling and drying due to small pores. The stress substantially increases contraction ratio after drying. The organic binder is added for the purpose of solving problems caused by the alkoxysilane, and a polymeric organic compound having C backbone structure may be used as the organic binder. The polymeric organic compound improves the coupling force among particles constituting the sol.

In the formation step, a gelling agent is added to the sol, which is then poured into a mold for gelling. After being separated from the mold, the gel is dried in a drying step.

In the heat treatment step, the dried gel is heated to a predetermined temperature to remove organic substances included in the gel. In the chlorine treatment step, metallic impurities and OH radicals remaining in the gel are removed, after removing the organic substances. In the high-temperature heat treatment step, the gel is subjected to heat treatment at a high temperature to consolidate the gel.

However, conventional sol-gel processes have a problem in that polymeric organic substances having C backbone structure decrease the purity of silica glass, such as an optical fiber preform or optical crystal fiber, manufactured by the sol-gel processes.

### SUMMARY OF THE INVENTION

One aspect of the present invention relates to a sol-gel process capable of minimizing the contamination of a sol-gel caused by remaining organic substances while preventing the decrease in the coupling force among particles of the sol-gel.

One embodiment of the present invention is directed to a sol-gel method including a dispersion step of mixing a sol having fumed silica dispersed into de-ionized water with a hydrolysis substance having an organic binder having Si—O backbone structure; a formation step of injecting the sol into a mold to form a gel; a drying step of drying the gel; a low-temperature heat treatment step of removing organic substances remaining in the gel; a chlorine treatment step of removing impurities remaining in the gel and OH radicals; and a high-temperature heat treatment step of heating the gel at a high temperature to improve the consolidation of the gel.

### BRIEF DESCRIPTION OF THE DRAWINGS

The above and other aspects, features and embodiments of the present invention will be more apparent from the following detailed description taken in conjunction with the accompanying drawings, in which:

FIG. 1 is a flowchart showing steps of a sol-gel method according to an embodiment of the present invention;

FIG. 2 is a flowchart showing sub-steps of the dispersion step shown in FIG. 1; and

FIG. 3 is a flowchart showing sub-steps of the formation step shown in FIG. 3.

### DETAILED DESCRIPTION

Hereinafter, embodiments of the present invention will be described with reference to the accompanying drawings. For the purposes of clarity and simplicity, a detailed description of known functions and configurations incorporated herein will be omitted when it may obscure the subject matter of the present invention.

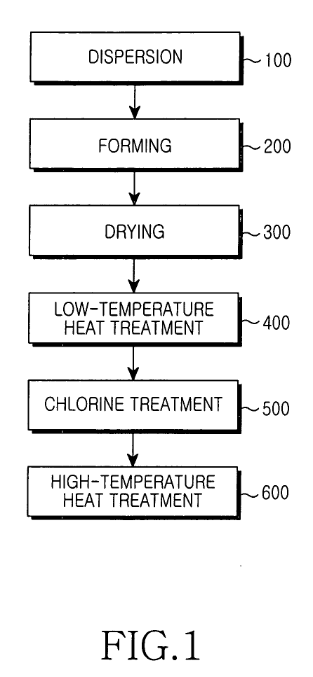

FIG. 1 is a flowchart showing steps of a sol-gel method according to an embodiment of the present invention. The method includes a dispersion step 100 of creating a sol, a forming step 200 of forming a gel by injecting the dispersed sol into a mold, a drying step 300, a low-temperature treatment step 400, a chlorine treatment step 400, and a high-temperature heat treatment step 600.

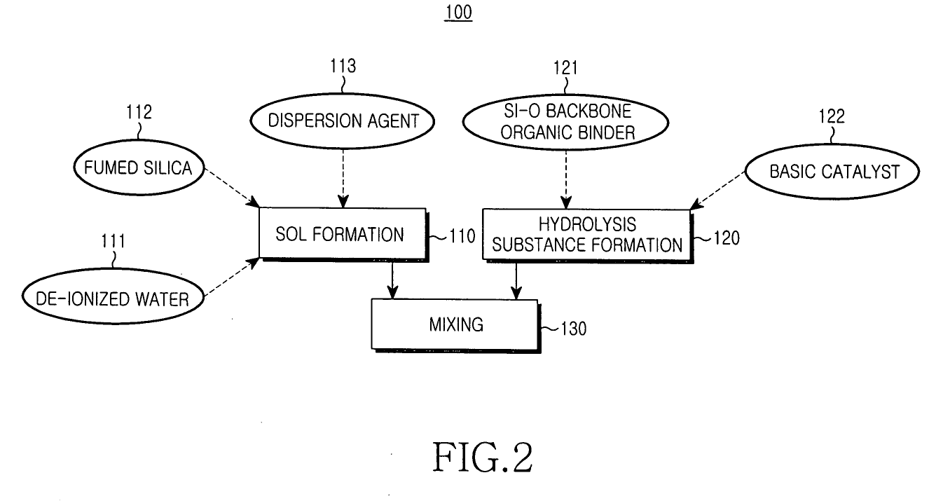

FIG. 2 is a flowchart showing sub-steps of the dispersion step 100 shown in FIG. 1. The dispersion step 100 includes a sol formation step 110 of fabricating a dispersed sol by adding fumed silica 112, a dispersion agent 113, and a plasticizer into a solution such as de-ionized water 111, a hydrolysis substance formation step 120 of forming a hydrolysis substance including an organic binder 121 and a basic catalyst 122, and a mixing step 130.

In the sol formation step 110, fumed silica 112 is added to de-ionized water 111 together with a dispersion agent 113 to form a sol. In the hydrolysis substance formation step 120, a hydrolysis substance having an organic binder 121 having Si—O backbone structure and a basic catalyst 122 added thereto is formed. In addition to the de-ionized water 111, alcohol may also be used as the solution.

The organic binder 121 includes polydimethylsiloxane having Si—O backbone structure as a polymer material. In one embodiment, the organic binder is added within a range of 0.5-3% of the entire sol. The organic binder 121 having Si—O backbone structure is composed of the same elements as the optical fiber or silica glass manufactured by the sol-gel and can suppress the degradation of purity of the manufactured optical fiber or silica glass.

In the mixing step 130, the sol and the hydrolysis substance are mixed to create a final sol.

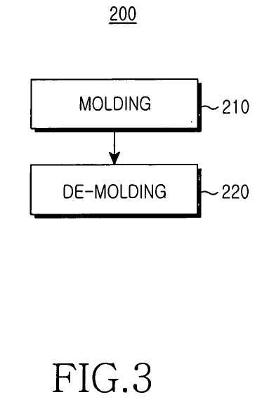

FIG. 3 is a flowchart showing sub-steps of the formation step 200 shown in FIG. 1. Referring to FIG. 3, the mixed sol is injected into a mold having a predetermined shape to form a gel in the forming step 200. According to the mold type, a secondary preform, which is used to manufacture an optical fiber preform, or an optical crystal fiber is formed. The forming step includes a molding step 210 for injecting the mixed sol into the mold for gelling and a de-molding step 220 for separating the gel created in the molding step 210 from the mold.

In the drying step 300, the gel separated from the mold is dried in a chamber having constant temperature and humidity.

In the low-temperature heat treatment step 400, the dried gel is subjected to heat treatment while supplying chlorine, hydrogen, oxygen, and the like to remove organic substances remaining in the gel. In the chlorine treatment step 500, impurities remaining in the gel and OH radicals are removed.

In the low-temperature heat treatment step 400 and the chlorine treatment step 500, which are also referred to as a purification step, impurities within the dried gel are removed.

In the high-temperature heat treatment step 600, the gel which has undergone the low-temperature heat treatment step 400 and the chlorine treatment step 500 are sintered and consolidated at a high temperature of 1200-1600° C. to vitrify it. As a result, a secondary preform to manufacture an optical fiber preform, an optical crystal fiber, or normal silica glass is obtained. The high-temperature heat treatment step 600 is performed with a furnace which vertically moves the gel, which has been subjected to organic substance treatment, in a high-temperature sintering furnace under a helium (He) gas atmosphere.

Polydimethylsiloxane having Si—O backbone structure may be added as an organic binder. It plays the role of a binder among particles constituting a sol-gel without degrading the purity of silica glass or optical fibers. An optical fiber perform manufactured in accordance with embodiments of the present invention can be used as a primary preform constituting the core portion of an optical fiber perform. Embodiments of the present invention can also be used to manufacture an optical crystal fiber demanding high purity.

Such sol-gel processes make it possible to manufacture an optical fiber preform without additional step of over-jacketing. This substantially reduces the entire process and saves production cost.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A sol-gel method comprising:
mixing a sol having fumed silica dispersed into de-ionized water with a hydrolysis substance having an organic binder having Si—O backbone structure;
injecting the sol into a mold to form a gel;
drying the gel;
removing organic substances remaining in the gel by a first heat treatment;
removing impurities remaining in the gel and OH radicals by a chlorine treatment; and
heating the gel to a second temperature that is higher than the first heat treatment to improve the consolidation of the gel.

2. A sol-gel method as claimed in claim 1, wherein the second temperature is equal to or greater than 1200 C.

3. A sol-gel method as claimed in claim 3, wherein the second temperature is less than or equal to 1600 C:

4. A sol-gel method as claimed in claim 1, wherein the step of mixing the sol comprises:
adding the fumed silica to the de-ionized water together with a dispersion agent to form a sol;
forming a hydrolysis substance having an organic binder having Si—O backbone structure and a basic catalyst added thereto; and
adding the hydrolysis substance to the sol.

5. A sol-gel method as claimed in claim 1, wherein the organic binder comprises a polymer material of polydimethylsiloxane having Si—O backbone structure.

6. A sol-gel method as claimed in claim 1, wherein the organic binder is added to the de-ionized water at a ratio of 0.5-3%.

7. A sol-gel method as claimed in claim 4, wherein the organic binder comprises polydimethylsiloxane having a molecular weight of 10,000-100,000.

8. A sol-gel method as claimed in claim 1, wherein the step of injecting the sol comprises:
injecting the sol, which has been mixed in the dispersion step, into a mold for gelling; and
separating the gel, which has been created in the molding step, from the mold.

9. A sol-gel method as claimed in claim 4, wherein the gel is subjected to heat treatment at a temperature of 1200-1600° C. in the heating step.

10. A method for manufacturing an optical crystal fiber using a sol-gel process comprising:
creating a sol by dispersing an organic binder having Si—O backbone structure into de-ionized water together with fumed silica;
injecting the dispersed sol into a mold to form a gel;
drying the gel;
removing organic substances remaining in the gel by a first heat treatment;
removing impurities remaining in the gel and OH radicals by a chlorine treatment;
heating the gel to a second temperature that is higher than the first heat treatment to improve the consolidation of the gel; and
drawing an optical crystal fiber from the consolidated gel.

11. A method for manufacturing an optical crystal fiber using a sol-gel process as claimed in claim 10, wherein the gel, which has been subjected to second heat treatment, is drawn into an optical crystal fiber at a temperature of 2000-2200° C. in the drawing step.
